(19) United States
(12) Patent Application Publication
(10) Pub. No.: US 2021/0256763 A1
(43) Pub. Date: Aug. 19, 2021

(54) METHOD AND DEVICE FOR SIMPLIFYING THREE-DIMENSIONAL MESH MODEL

(71) Applicant: SZ DJI TECHNOLOGY CO., LTD., Shenzhen (CN)

(72) Inventors: Sheng HUANG, Shenzhen (CN); Jiabin LIANG, Shenzhen (CN)

(21) Appl. No.: 17/307,124

(22) Filed: May 4, 2021

Related U.S. Application Data
(63) Continuation of application No. PCT/CN2018/114550, filed on Nov. 8, 2018.

(51) Int. Cl. G06T 17/20; G06T 19/20; G06T 7/73

(52) U.S. Cl. CPC G06T 17/205; G06T 2219/2021; G06T 7/75; G06T 19/20

(57) ABSTRACT

A method for simplifying a three-dimensional mesh model includes obtaining N non-boundary edges of the three-dimensional mesh model; for each non-boundary edge of the N non-boundary edges, determining a deletion error of the non-boundary edge, determining a deletion weight of the non-boundary edge according to a feature parameter of each vertex of two vertices of the non-boundary edge, and adjusting the deletion error of the non-boundary edge according to the deletion weight of the non-boundary edge to obtain an adjusted deletion error of the non-boundary edge; and simplifying the three-dimensional mesh model according to the adjusted deletion errors of the N non-boundary edges. N is an integer larger than one.

### CROSS-REFERENCE TO RELATED APPLICATION

This application is a continuation of International Application No. PCT/CN2018/114550, filed Nov. 8, 2018, the entire content of which is incorporated herein by reference.

### TECHNICAL FIELD

The present disclosure relates to the field of image processing technologies and, more particularly, to a method and a device for simplifying a three-dimensional mesh model.

### BACKGROUND

As computing power and graphics card performance of computers develop, fine three-dimensional models have been widely used since the fine three-dimensional models can accurately display details of real objects in all directions, greatly improving the practicability and appreciation of three-dimensional models. However, a fine three-dimensional model of a large scene often contains a huge amount of three-dimensional vertices and triangles. A huge amount of data causes the three-dimensional model to consume a lot of graphics card resources during rendering process. Correspondingly, the rendering speed is slower, often causing a sense of sluggishness in human-computer interaction. Larger-scale popularization and application of fine three-dimensional models are impeded.

### SUMMARY

In accordance with the disclosure, there is provided a method for simplifying a three-dimensional mesh model including obtaining N non-boundary edges of the three-dimensional mesh model; for each non-boundary edge of the N non-boundary edges, determining a deletion error of the non-boundary edge, determining a deletion weight of the non-boundary edge according to a feature parameter of each vertex of two vertices of the non-boundary edge, and adjusting the deletion error of the non-boundary edge according to the deletion weight of the non-boundary edge to obtain an adjusted deletion error of the non-boundary edge; and simplifying the three-dimensional mesh model according to the adjusted deletion errors of the N non-boundary edges. N is an integer larger than one.

Also in accordance with the disclosure, there is provided a device for simplifying a three-dimensional mesh model including a memory storing a computer program and a processor configured to execute the computer program to obtain N non-boundary edges of the three-dimensional mesh model; for each non-boundary edge of the N non-boundary edges, determine a deletion error of the non-boundary edge, determine a deletion weight of the non-boundary edge according to a feature parameter of each vertex of two vertices of the non-boundary edge, and adjust the deletion error of the non-boundary edge according to the deletion weight of the non-boundary edge to obtain an adjusted deletion error of the non-boundary edge; and simplify the three-dimensional mesh model according to the adjusted deletion errors of the N non-boundary edges. N is an integer larger than one.

### BRIEF DESCRIPTION OF THE DRAWINGS

The above and/or additional aspects and advantages of this disclosure will become obvious and easy to understand from the description of the embodiments in conjunction with the following drawings.

FIG. 1 is a flow chart of an exemplary method for simplifying a three-dimensional mesh model consistent with various embodiments of the present disclosure.

FIG. 2 is a flow chart of another exemplary method for simplifying a three-dimensional mesh model consistent with various embodiments of the present disclosure.

FIG. 3 is a flow chart of another exemplary method for simplifying a three-dimensional mesh model consistent with various embodiments of the present disclosure.

FIG. 4 is a schematic diagram showing deletion of non-boundary edges consistent with various embodiments of the present disclosure.

FIG. 5 is a flow chart of another exemplary method for simplifying a three-dimensional mesh model consistent with various embodiments of the present disclosure.

FIG. 6 shows an exemplary position relationship between a model object and a camera consistent with various embodiments of the present disclosure.

FIG. 7 shows an exemplary original three-dimensional model before being simplified consistent with various embodiments of the present disclosure.

FIG. 8 shows an exemplary original three-dimensional model after being simplified with a method consistent with various embodiments of the present disclosure.

FIG. 9 shows an exemplary original three-dimensional model after being simplified.

FIG. 10 is a structural diagram of an exemplary device for simplifying a three-dimensional mesh model consistent with various embodiments of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

As the computing power and graphics card performance of computers develop, a number of fine three-dimensional models becomes larger and larger. The fine three-dimensional models can accurately display details of real objects from 360°, greatly improving the practicability and appreciation of three-dimensional models. However, a fine three-dimensional model of a large scene often contains a huge amount of three-dimensional vertices and triangular faces. A huge amount of data causes the three-dimensional model to consume a lot of graphics card resources during the rendering process. Correspondingly, the rendering speed is slower, often causing a sense of sluggishness in human-computer interaction. Larger-scale popularization and application of fine three-dimensional models are weakened.

Mesh simplification technologies may use geometric information of a mesh for simplification. For example, via vertices clustering, vertices classified into one category are merged into one point, and the topology information is updated, while some very practical information when the mesh is generated is discarded. For example, the influence of distances between triangle mesh vertices and the camera, as well as flatness (curvature) of a region, on the three-dimensional mesh model, is discarded. Correspondingly, difference between the simplified three-dimensional mesh model and the actual object is large, and the characteristic information of the physical object cannot be accurately reflected.

The present disclosure provides a method for simplifying a three-dimensional mesh model. In the method, deletion weight of each non-boundary edge may be determined according to feature parameters of two vertices of the non-boundary edge including distances between the two vertices and camera, curvatures at the two vertices, or color values at the two vertices. Then a deletion error of each non-boundary edge may be determined according to the deletion weight of the non-boundary edge. Correspondingly, deletion errors of non-boundary edges may be more consistent with reality, and detailed features of objects may be retained. The quality of the simplified three-dimensional mesh model may be improved.

One embodiment of the present disclosure provides a method for simplifying a three-dimensional mesh model. The method may be executed by a device with a function of simplifying a three-dimensional mesh model, for example, a device for simplifying a three-dimensional mesh model (hereinafter referred to as a simplifying device). The simplifying device may be implemented by software and/or hardware.

Optionally, in one embodiment, the simplifying device may be a part of an electronic device. For example, the simplifying device may be a processor of the electronic device.

Optionally, in another embodiment, the simplifying device may be an independent electronic device.

The electronic device may include a smartphone, a desktop computer, a laptop computer, a smart bracelet, an augmented reality (AR) device, or a virtual application (VA) device.

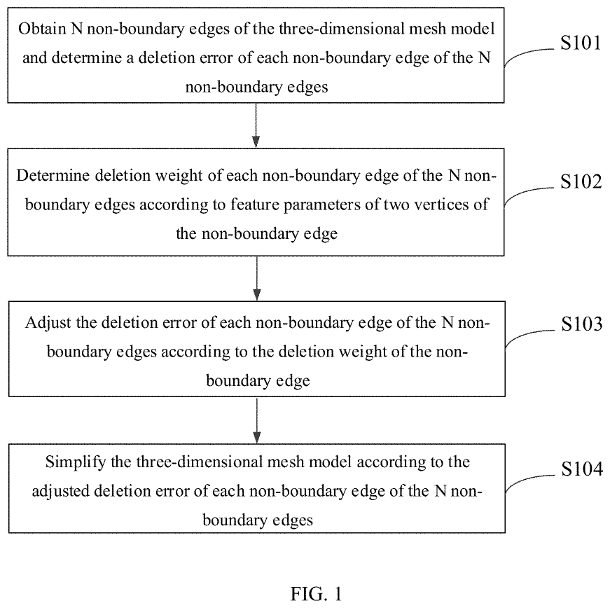

As shown in FIG. 1, the method for simplifying the three-dimensional mesh model includes S101 to S104.

In S101, N non-boundary edges of the three-dimensional mesh model are obtained, and a deletion error of each non-boundary edge of the N non-boundary edges is determined. N is an integer larger than one.

In one embodiment, the three-dimensional mesh model may be generated based on a plurality of captured pictures. The plurality of pictures may be captured by an unmanned aerial vehicle for aerial photographing, or be captured by a user using one or more cameras.

After the three-dimensional mesh model is obtained, the three-dimensional mesh model may be analyzed to obtain edges of the three-dimensional mesh model. The edges of the three-dimensional mesh model may include boundary edges and non-boundary edges. The boundary edges may be edges owned by one triangular face, and the non-boundary edges may be edges owned by at least two triangular faces. Since deletion of the boundary edges of the three-dimensional mesh model may affect the integrity of the three-dimensional mesh model, when simplifying the three-dimensional mesh model, the non-boundary edges of the three-dimensional mesh model may be mainly used as the research objects.

For example, in one embodiment, the three-dimensional mesh model may be a triangular face mesh model. The three-dimensional mesh model may include a certain number of vertices and triangular faces. All edges in the triangle mesh model may be obtained and how many triangular faces which are shared by each edge may be calculated. For example, for one edge, all triangular faces may be traversed and the number of triangular faces that contain this edge may be determined. When the number of triangular faces containing this edge is one, the edge may be a boundary edge. When the number of triangular faces containing this edge is at least two, this edge may be a non-boundary edge. Correspondingly, all non-boundary edges may be obtained. After obtaining the N non-boundary edges of the three-dimensional mesh model, the deletion error of each non-boundary edge in the N non-boundary edges may be determined. For description purposes only, the present embodiment with the triangular mesh model is used as an example to illustrate the present disclosure and does not limit the scope of the present disclosure. In various embodiments, it can be understood that the three-dimensional mesh model may also include a mesh model of other suitable shapes, such as a trapezoidal mesh model.

The deletion error of one non-boundary edge may indicate the amount of change of the whole three-dimensional mesh model induced by the deletion of the non-boundary edge. When the deletion error of one non-boundary edge is larger, this non-boundary edge may be more important to the three-dimensional mesh model and the possibility for this non-boundary edge to be deleted may be smaller. Further, the deletion error of one non-boundary edge may be determined by calculating a distance from a newly generated vertex after deleting this non-boundary edge to the original triangular face. In another embodiment, the deletion error of one non-boundary edge may be determined according to a distance from a midpoint of this non-boundary edge or another suitable point to the original triangular face. For example, in one embodiment, when a sum of the distances from the newly generated vertex, the midpoint of the non-boundary edge, or another suitable point, to the original triangular face, is smallest, the deletion error of the non-boundary edge may be smallest.

In one embodiment, the deletion error of each non-boundary edge may be determined by a method of quadratic error measurement. The method will be described below using non-boundary edge l of the N non-boundary edges as an example.

The non-boundary edge l may be (v₁, v₂) where v₁ and v₂ are two vertices of the non-boundary edge l. A triangular face where the non-boundary edge l is located may be (v₁, v₂, v₃).

First, a quadratic error measurement matrix of each vertex of the vertices v₁ and v₂, that is, a Q matrix, may be calculated. The Q matrix of each vertex of the vertices v₁ and v₂ may reflect a sum of squared distances from the vertex to surrounding triangular faces. The Q matrix of the vertex v₁ will be used as an example to illustrate the calculation of the Q matrix. The process for the vertex v₂ is similar.

A unit normal vector of the vertex v₁ may be calculated. The normal vector may be a normal vector of a triangular face where the vertex v₁ is located. The normal vector of the triangular face may be calculated as [symbol] = [symbol] × [symbol] where “x” is vector cross product. After the normal vector is obtained, the normal vector may be unitized.

Coordinates of the vertex v₁ may be already known. Assuming the coordinates of the vertex v₁ are p=(x,y,z,1)^{T}, and there is a three-dimensional plane q=(a,b,c,d)^{T} satisfying ax+by+cz+d=0. The coefficients of the plane may satisfy (a, b, c)= [symbol] and d=−(ax+by+cz). In this disclosure, unless otherwise specified, a plane refers to a flat plane.

Since the normal vector n is three-dimensional, the coefficients a, b, c, and d may be obtained according to the above description.

The Q matrix Q₁ of the vertex v₁ may be obtained as

$${Q}_{1} = [ \begin{matrix}{a}^{2} & a b & a c & a d \\ a b & {b}^{2} & b c & b d \\ a c & b c & {c}^{2} & c d \\ a d & b d & c d & {d}^{2}\end{matrix} ] .$$

The Q matrix Q₂ of the vertex v₂ may be obtained similarly.

Then the deletion error of the non-boundary edge l may be calculated.

Q matrices, Q₁ and Q₂, of the vertex v₁ and the vertex v₂, respectively, may be calculated according to above. A newly generated vertex after the non-boundary edge l is deleted may be p, and a Q matrix of the vertex p may be Qₚ=(Q₁+Q₂).

Coordinates (homogeneous coordinate representation) of the newly generated vertex p may be calculated by solving the equation

$$[ \begin{matrix}{q}_{11} & {q}_{12} & {q}_{13} & {q}_{14} \\ {q}_{12} & {q}_{22} & {q}_{23} & {q}_{24} \\ {q}_{13} & {q}_{14} & {q}_{33} & {q}_{34} \\ 0 & 0 & 0 & 1\end{matrix} ] p = [ \begin{matrix}0 \\ 0 \\ 0 \\ 1\end{matrix} ]$$

where qᵢⱼ is a corresponding element in the matrix Qₚ. If the coefficient matrix in the above equation is invertible, p may be the unique solution of the equation and the calculated unique solution p may be the vertex with the smallest sum of squared distances to the surrounding triangular faces. Correspondingly, the deletion error of the non-boundary edge l may be determined according to the distance from the newly generated vertex to the original triangular face.

If the coefficient matrix in the above equation is not invertible, the equation may have infinite number of solutions. Correspondingly, it may be determined that p=½(v₁+v₂), that is, a midpoint of the non-boundary edge l may be obtained. The deletion error of the non-boundary edge l may be determined according to the midpoint of the non-boundary edge l.

The deletion error of the non-boundary edge l may be determined to be p^{T}Qₚp.

The deletion error of each non-boundary edge of the N non-boundary edges may be determined according to the above method.

In S102, for each non-boundary edge of the N non-boundary edges, the deletion weight of the non-boundary is determined according to feature parameters of the two vertices of the non-boundary edge.

The feature parameters of the two vertices of the non-boundary edge may include, but may not be limited to, one or more of distances from the vertices to the camera, curvatures at the vertices, and color values at the vertices. In this disclosure, the distance from a vertex to a camera (the distance between the vertex and the camera) refers to the distance between a spatial point associated with the vertex and a spatial position of the camera when the camera captures a photo containing the vertex, and is also referred to as a “camera distance” of the vertex. The spatial position of the camera is also referred to as a “camera position,” and can be, e.g., a center of the camera. The same vertex may appear in a plurality of photos captured by one camera at different times (at different camera positions) or by a plurality of cameras (having different different camera positions) at a same time. Therefore, a vertex may be associated with a plurality of camera distances.

For example, in one embodiment, in the process of using aerial images to generate a three-dimensional model, the triangular mesh may be generated through dense point clouds, and these dense point clouds may be extracted from the information between photos. Each photo may represent a camera position, and the true position of each camera can be calculated. Therefore, in the process of simplifying the mesh, the factor of the camera distance of each vertex may be taken into account in the present disclosure. Objects close to the camera may be clear and detailed, and the details of objects far away from the camera may be slightly blurred. Correspondingly, in the actual three-dimensional mesh model, the scene closer to the camera may have more details, that is, more triangular faces may be retained. In the scene far away from the camera, fewer triangular faces may be reserved. Correspondingly, the camera distances of the vertices of each non-boundary edge can be used to set the deletion weight of the non-boundary edge, such that the simplified three-dimensional mesh model retains more detailed information.

For example, a plane can be described by three points, and a complex shape structure may require more points to describe this information. Planar and non-planar areas may be found in the scene. Weights of the triangular edges of the planar areas may be set to be very small and weights of the triangular edges of complex-shaped areas may be set to large. As such, in the simplification process, more triangular faces in the planar area may be deleted and the triangular faces in the complex areas may be preserved to the greatest extent. In this sense, the curvatures at the two vertices of each non-boundary edge can be used to set the deletion weight of the non-boundary edge, such that the simplified three-dimensional mesh model may retain more important information.

For example, in one embodiment, when the colors around the vertices are more consistent, the probability that these vertices are on a plane may be larger and also the probability that they can be deleted may be larger. In this sense, the color consistency around the vertices may be used to set the deletion weight of each non-boundary edge.

For description purposes only, the previous embodiments with the feature parameters of the two vertices of each non-boundary edge are used as examples to illustrate the present disclosure, and do not limit the scopes of the present disclosure. In various embodiments, the feature parameters of the two vertices of each non-boundary edge may include any suitable parameters. For example, in another embodiment, the feature parameters of the two vertices of each non-boundary edge may include shape quality of triangular faces where the vertices are located. That is, when the shape quality of the triangular faces where the vertices are located is better, the consistency of the normal vectors of the vertices may be higher and the probability that they can be deleted may be higher. In this way, the shape quality of the triangular faces where the vertices are located may be used to set the deletion weight of the non-boundary edge.

Optionally, in one embodiment, the deletion weight of each non-boundary edge may be determined based on the same characteristic parameters of the vertices. For example, the deletion weight of each non-boundary edge may be determined based on the camera distance of the vertices.

Optionally, in another embodiment, the deletion weights of different non-boundary edges can be determined based on different feature parameters of the vertices. For example, for some non-boundary edges, the deletion weight of a non-boundary edge can be determined based on the camera distances of the vertices of the non-boundary edge, while for some other non-boundary edges, th deletion weight of a non-boundary edge can be determined based on the curvatures at the vertices of the non-boundary edge.

That is, in various embodiments, the deletion weights of different non-boundary edges can be calculated based on same or different feature parameters. The specific parameters may be used according to actual conditions, and the present disclosure has no limit on this.

Optionally, the deletion weight of each non-boundary edge may be determined based on a plurality of characteristic parameters of the vertices. For example, the deletion weight corresponding to each characteristic parameter of the plurality of characteristic parameters may be calculated, and then the deletion weights corresponding to various characteristic parameters may be superimposed to obtain the deletion weight of the non-boundary edge.

In S103, the deletion error of each non-boundary edge may be adjusted according to the deletion weight of the non-boundary edge.

After the deletion error and the deletion weight of each non-boundary edge is obtained, the deletion error of each non-boundary edge may be adjusted according to the deletion weight of the non-boundary edge.

In one embodiment, for each non-boundary edge, the deletion error minus the deletion weight may be used as the adjusted deletion error of the non-boundary edge.

In another embodiment, for each non-boundary edge, the deletion error plus the deletion weight may be used as the adjusted deletion error of the non-boundary edge.

In another embodiment, for each non-boundary edge, the deletion error multiplied by the deletion weight may be used as the adjusted deletion error of the non-boundary edge.

In some other embodiments, other manners may be used to adjust the deletion error of each non-boundary edge according to the deletion weight of the non-boundary edge.

In S104, the three-dimensional mesh model is simplified according to the adjusted deletion error of each non-boundary edge.

The deletion error of each non-boundary edge may be adjusted, such that the adjusted deletion error may be more realistic. Simplification of the three-dimensional mesh model based on the deletion errors of each non-boundary edge conforming to reality can improve the quality of the simplified three-dimensional mesh model.

In one embodiment, simplifying the three-dimensional mesh model based on the adjusted deletion error of each non-boundary edge may include sorting the adjusted deletion error of each non-boundary edge, and deleting non-boundary edges with small adjusted deletion error, to realize the simplification of the three-dimensional mesh model.

In the present disclosure, the N non-boundary edges of the three-dimensional mesh model may be obtained, and the deletion error of each non-boundary edge of the N non-boundary edges may be determined. Then the deletion weight of each non-boundary edge may be determined based on the feature parameters of the two vertices of each non-boundary edge, and the deletion error of each non-boundary edge may be adjusted according to the deletion weight of the non-boundary edge. The three-dimensional mesh model may be simplified according to the adjusted deletion error of each non-boundary edge. The influence of the feature parameters of the vertices of each non-boundary edge on the simplification of the three-dimensional mesh model may be taken into account, and the deletion weight of each non-boundary edge may be determined based on the feature parameters of the two vertices of each non-boundary edge. The deletion error of each non-boundary edge may be adjusted according to the deletion weight of the non-boundary edge, such that the adjusted deletion error may more conform to the reality and the quality of the simplification of the three-dimensional mesh model may be improved.

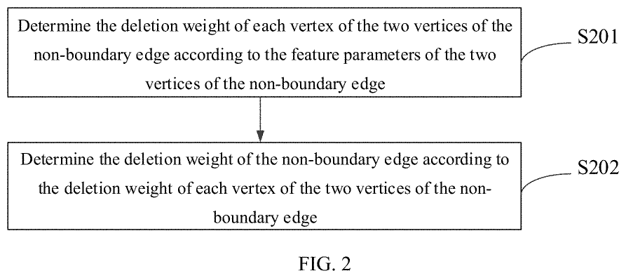

The present disclosure also provides another method for simplifying a three-dimensional mesh model, which includes a detailed process for determining the deletion weight of each non-boundary edge of the N non-boundary edges according to the feature parameters of the two vertices of the non-boundary edge. As illustrated in FIG. 2, for each non-boundary edge of the N non-boundary edges, determining the deletion weight of the non-boundary edge according to the feature parameters of the two vertices of the non-boundary edge in S102 includes determining the deletion weight of each vertex of the two vertices of the non-boundary edge according to the feature parameters of the two vertices of the non-boundary edge (S201) and determining the deletion weight of the non-boundary edge according to the deletion weight of each vertex of the two vertices of the non-boundary edge (S202).

The following embodiments will be used to illustrate the implementation of S201 and S202 in the present disclosure, and do not limit the scope of the present disclosure.

In one embodiment, the feature parameters of the two vertices may include camera distances of the vertices. Correspondingly, S201 may include: for each vertex of the two vertices, obtaining a minimum camera distance among all the camera distances of the vertex (that is, the distances from the vertex to all the camera positions, i.e., positions of camera(s) at the time(s) of taking the photos containing the vertex, also referred to as “candidate camera distances” of the vertex), and determining the deletion weight of the vertex according to the minimum camera distance corresponding to the vertex. The smaller is the minimum camera distance corresponding to a vertex, the larger the deletion weight of the vertex may be.

Optionally, for each vertex of the two vertices, obtaining the minimum camera distance among the camera distances of the vertex may include: obtaining all camera poses in the coordinate system of the three-dimensional mesh model, determining all the camera distances of the vertex according to all the camera poses, and using a minimum one among all the camera distances as the minimum camera distance corresponding to the vertex. The camera pose as used in this disclosure refers to the pose of a camera when taking a photo. The camera poses in the coordinate system of the three-dimensional model can be obtained, e.g., through a structure from motion method.

Optionally, other methods may be used to obtain the minimum camera distance among all the camera distances of the vertex.

The non-boundary edge l will be used as an example to illustrate the present disclosure and other non-boundary edges may be processed accordingly.

The non-boundary edge l may include a vertex v₁ and a vertex v₂. All camera distances of the vertex v₁ may be obtained and a minimum one among these camera distances, i.e., the minimum camera distance of the vertex v₁, may be determined as d₁. All camera distances of the vertex v₂ may be obtained and a minimum one among these camera distances, i.e., the minimum camera distance of the vertex v₂, may be determined as d₂.

Subsequently, the deletion weight of the vertex v₁ may be determined according to the minimum camera distance d₁ corresponding to the vertex v₁, and the deletion weight of the vertex v₂ may be determined according to the minimum camera distance d₂ corresponding to the vertex v₂. The larger is the camera distance of one vertex, the smaller the deletion weight of the vertex may be and the easier may the vertex be removed in the simplification of the mesh model. That is, the smaller is the minimum camera distance of a vertex, the larger the corresponding deletion weight may be. For example, the smaller is d₁, the larger the deletion weight of the vertex v₁ may be, and the smaller is d₂, the larger the deletion weight of the vertex v₂ may be, and correspondingly it may be harder for the vertex to be removed in the simplification of the mesh model.

Optionally, a reciprocal of a square of the minimum camera distance corresponding to one vertex may be used as the deletion weight of the vertex. For example, 1/d₁² may be used as the deletion weight of the vertex v₁, and 1/d₂² may be used as the deletion weight of the vertex v₂.

In the present disclosure, when the feature parameters of one vertex include the camera distances of the vertex, the deletion weight of each vertex of the two vertices of the non-boundary edge may be determined according to the above description.

The deletion weight of the non-boundary edge may be determined according to the deletion weight of each vertex of the two vertices of the non-boundary edge.

Optionally, an average of the deletion weight of the two vertices of the non-boundary edge may be used as the deletion weight of the non-boundary edge. For example, the deletion weight of the non-boundary edge l may be an average of 1/d₁² and 1/d₂². The average may be a weighted average or a numerical average.

In another embodiment, the feature parameters of the vertices may include the curvatures at the vertices. Correspondingly, S201 may include: obtaining the curvature at each vertex of the vertices of one non-boundary edge and determining the deletion weight of each vertex of the vertices of the non-boundary edge according to the corresponding curvature. The larger is the curvature at a vertex, the larger the deletion weight of the vertex may be.

The non-boundary edge l will be used as an example to illustrate the method, and other non-boundary edges may be processed accordingly.

The non-boundary edge l may include the vertex v₁ and the vertex v₂. Correspondingly, the curvature at the vertex v₁ and the curvature at the vertex v₂ may be determined according to

$$ρ = \frac{\sqrt{{( {z}^{″} {y}^{′} - {y}^{″} {z}^{′} )}^{2} + {( {x}^{″} {z}^{′} - {z}^{″} {x}^{′} )}^{2} + {( {y}^{″} {x}^{′} - {x}^{″} {y}^{′} )}^{2}}}{{( {x}^{′ 2} + {y}^{′ 2} + {z}^{′ 2} )}^{\frac{3}{2}}}$$

where x, y, and z are coordinates of the vertex, x′ and x″ are a first derivative and second derivative of the function, respectively. The range of the curvature ρ is [0,1]. The curvature at the vertex v₁ and the curvature at the vertex v₂ may be obtained as ρ₁ and ρ₂, respectively.

The deletion weight of the vertex v₁ and the deletion weight of the vertex v₂ may be determined according to the curvature at the vertex v₁ and the curvature at the vertex v₂. The smaller is the curvature at a vertex, the smaller a degree of curving at the vertex may be, and the larger the possibility for the vertex to be deleted may be. That is, the larger is the curvature at one vertex, the larger the deletion weight of the vertex may be. For example, the larger is ρ₁, the larger the deletion weight of the vertex v₁ may be; or the larger is ρ₂, the larger the deletion weight of the vertex v₂ may be; and the less likely may the vertex be deleted in the simplification of the mesh model.

Optionally, a square of the curvature at one vertex may be used as the deletion weight of the vertex. For example, the deletion weight of the vertex v₁ may be ρ₁², and the deletion weight of the vertex v₂ may be ρ₂².

In the present disclosure, when the feature parameters of the vertices include the curvatures at the vertices, the deletion weight of each vertex of the two vertices of each non-boundary edge may be determined according to the previous description.

The deletion weight of the non-boundary edge may be determined according to the deletion weight of each vertex of the two vertices of the non-boundary edge.

Optionally, an average of the deletion weight of the two vertices of the non-boundary edge may be used as the deletion weight of the non-boundary edge. For example, the deletion weight of the non-boundary edge l may be an average of ρ₁² and ρ₂². The average may be a weighted average or a numerical average.

In another embodiment, the feature parameters of one vertex may include a color value at the vertex. Correspondingly, S201 may include: obtaining the color values at the two vertices of the non-boundary edge and the color values at vertices surrounding the two vertices; and for each vertex of the two vertices, determining the deletion weight of the vertex according to a variance between the color value at the vertex and the color values at the surrounding vertices. The larger is the variance between the color value at the vertex and the color values at the surrounding vertices, the larger the deletion weight of the vertex may be. In this disclosure, the variance between the color value at a vertex and the color values at surrounding vertices of the vertex is also referred to as a “color variance” of the vertex.

The more consistent is the color of one vertex with the color of the surrounding vertices, the larger the possibility that the vertex is located at a plane may be, and the larger the possibility for the vertex to be deleted may be.

The non-boundary edge l will be used as an example to illustrate the method, and other non-boundary edges may be processed accordingly.

The non-boundary edge l may include the vertex v₁ and the vertex v₂. The color value y₁ at the vertex v₁ and the color values at vertices surrounding the vertex v₁ may be obtained. The color value y₂ at the vertex v₂ and the color values at vertices surrounding the vertex v₂ may be obtained.

The variance between the color value at the vertex v₁ and the color values at the vertices surrounding the vertex v₁, and the variance between the color value at the vertex v₂ and the color values at the vertices surrounding the vertex v₂ may be determined. Since the vertex v₁ and the vertex v₂ are surrounding vertices for each other, the variance between the color value at the vertex v₁ and the color value at the vertex v₂ may be calculated. Optionally, calculation of the variance of the color values at the vertices may be performed separately on three RGB channels.

When the above variances are very small (for example, are less than 1), the color of these points may be considered to be consistent, and the vertex v₁ and the vertex v₂ may be easier to be deleted in the simplification of the mesh model. That is, for one vertex, the smaller is the variance between the color value at the vertex and the color values at the surrounding vertices, the smaller the deletion weight of the vertex may be and the easier may the vertex be deleted.

Optionally, for one vertex, the variance between the color value at the vertex and the color values at the surrounding vertices may be used as the deletion weight of the vertex.

In the present disclosure, when the feature parameters of the vertices include the color values at the vertices, the deletion weight of each vertex of the two vertices of the non-boundary edge may be determined according to the above description.

For description purposes only, the above embodiments with the feature parameters of the two vertices of the non-boundary edge described above are used as examples to illustrate the present disclosure, and do not limit the scope of the present disclosure. For example, in one embodiment, for one vertex, the feature parameters of the vertex may include a shape quality of a triangular face where the vertex is located. That is, the better is the shape quality of the triangular face where the vertex, the higher the consistency of the vertex normal vectors may be and the larger the possibility for the vertex to be deleted may be. Correspondingly, for each vertex of the two vertices of the non-boundary edge, the shape quality of the triangular face where the vertex is located may be used to obtain the deletion weight of the vertex. Optionally, an average of the deletion weights of the two vertices of the non-boundary edge may be used as the deletion weight of the non-boundary edge.

In the present disclosure, the feature parameters of one vertex may include one or more of the camera distance of the vertex, the curvature at the vertex, and the color value at the vertex. The deletion weight of each vertex of the two vertices of the non-boundary edge may be determined. Then the deletion weight of the non-boundary edge may be determined according to the deletion weight of each vertex of the two vertices of the non-boundary edge. Accurate determination of the deletion weight of the non-boundary edge may be achieved.

The present disclosure provides two example manners to implement simplifying the three-dimensional mesh model according to the adjusted deletion error of each non-boundary edge in S104.

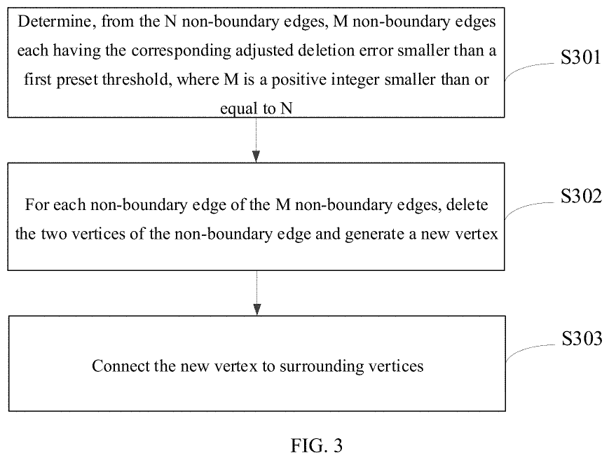

In one embodiment, as shown in FIG. 3, based on the previous embodiments, simplifying the three-dimensional mesh model according to the adjusted deletion error of each non-boundary edge in S104 includes S301 to S303.

In S301, M non-boundary edges each having the corresponding adjusted deletion error smaller than a first preset threshold are determined from the N non-boundary edges. M is a positive integer smaller than or equal to N.

In the present embodiment, the adjusted deletion errors of the N non-boundary edges may be sorted and the sorting may be from large to small, or from small to large.

The deletion errors of the M non-boundary edges smaller than the first preset threshold among the adjusted deletion errors of N non-boundary edges may be obtained.

In S302, for each non-boundary edge of the M non-boundary edges, the two vertices of the non-boundary edge are deleted and a new vertex is generated.

In S303, the new vertex is connected to surrounding vertices.

The M non-boundary edges with the deletion errors smaller than the first preset threshold are non-boundary edges that need to be deleted in the simplification of the mesh model.

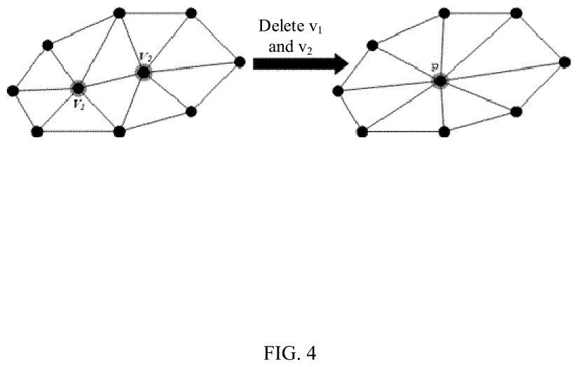

Using the non-boundary edge l as an example and assuming the non-boundary edge l belongs to the M non-boundary edges, as shown in FIG. 4, the non-boundary edge l may be deleted by: deleting the two vertices v1 and v2 of the non-boundary edge l by merging v1 and v2 to a new vertex p; and connecting the new vertex p to surrounding vertices. Other non-boundary edges in the M non-boundary edges may be deleted in a same way.

In the present disclosure, the M non-boundary edges with the adjusted deletion errors smaller than the first preset threshold may be deleted to simplify the mesh model. The simplified mesh model may be more consistent with reality and may have a higher quality. The entire deletion process may be simple and may be completed at one time.

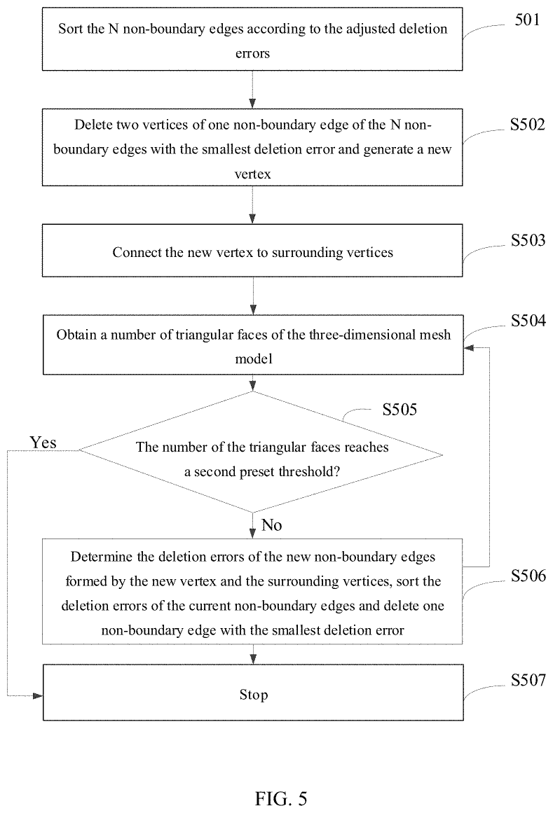

In one embodiment, as shown in FIG. 5, based on the previous embodiments, simplifying the three-dimensional mesh model according to the adjusted deletion error of each non-boundary edge in S104 may include S501 to S507.

In S501, the N non-boundary edges are sorted according to the adjusted deletion errors.

In S502, two vertices of one non-boundary edge of the N non-boundary edges with the smallest deletion error are deleted and a new vertex is generated.

In S503, the new vertex is connected to surrounding vertices.

In the present embodiment, the non-boundary edge with the smallest deletion error is deleted one by one. Specifically, the N non-boundary edges are sorted according to the adjusted deletion errors of the N non-boundary edges and then the non-boundary edge with the smallest deletion error is deleted.

In S504, a number of triangular faces of the three-dimensional mesh model is obtained.

In S505, it is determined whether the number of the triangular faces reaches a second preset threshold.

In S506, when it is determined the number of the triangular faces does not reach the second preset threshold, deletion errors of new non-boundary edges formed by the new vertex and the surrounding vertices are determined. Then the deletion errors of the current non-boundary edges are sorted, and one non-boundary edge of the current non-boundary edges with the smallest deletion error is deleted. Subsequently, S504 is executed again.

In S507, when it is determined the number of the triangular faces reaches the second preset threshold, the simplification is completed.

The number of the triangular faces in the current three-dimensional mesh model is obtained. For example, Every time one non-boundary edge is deleted, two triangular faces are deleted. In this way, the initial number of the triangular faces of the three-dimensional mesh model minus the number of the triangular faces that are currently deleted by deleting the non-boundary edge results in the number of current remaining triangular faces. Optionally, it is also possible to traverse to obtain the number of current remaining triangular faces.

It is determined whether the number of the triangular faces of the current three-dimensional mesh model reaches the second preset threshold. When it is determined that the number of the triangular faces reaches the second preset threshold, the simplification is completed. When it is determined whether the number of the triangular faces does not reach the second preset threshold, the deletion errors of the new non-boundary edges formed by the new vertex and the surrounding vertices are determined. Then the deletion errors of the current non-boundary edges are sorted, and one non-boundary edge of the current non-boundary edges with the smallest deletion error is deleted. Subsequently, S504 to S506 are executed repeatedly until the number of the triangular faces of the three-dimensional mesh model reaches the second preset threshold.

In the present disclosure, the non-boundary edge with the smallest deletion error may be deleted one by one, and the accuracy of the simplification of the three-dimensional mesh model may be improved further.

In one embodiment, deleting the two vertices of the non-boundary edge and generating a new vertex may include: determining whether the deletion of the non-boundary edge will cause the corresponding triangular face to flip or generate a sharp triangular face; when the deletion of the non-boundary edge will not cause the triangular face to flip or generate a sharp triangular face, deleting the non-boundary edge and generating the new vertex according to the two vertices of the non-boundary edge.

In the present disclosure, to ensure the integrity and accuracy of the mesh model after deleting non-boundary edges, every time a non-boundary edge is deleted, it is determined whether the deletion of the non-boundary edge will cause a sudden change in the shape of the mesh model. For example, it is determined whether the deletion of the non-boundary edge will cause the triangular face to flip or generate a sharp triangular face. When the deletion of the non-boundary edge will cause the triangular face to flip or generate a sharp triangular face, the non-boundary edge cannot be deleted. When the deletion of the non-boundary edge will not cause the triangular face to flip or generate a sharp triangular face, the non-boundary edge can be deleted. The reliability of non-boundary edge deletion and the integrity of the mesh model may be ensured.

Optionally, generating the new vertex according to the two vertices of the non-boundary edge may include: obtaining secondary error measurement matrices of the two vertices of the non-boundary edge; and determining the coordinates of the new vertex according to a sum matrix of the secondary error measurement matrices of the two vertices.

Using the non-boundary edge l as an example, the two vertices of the non-boundary edge l are v₁ and v₂. The secondary error measurement matrix of the vertex v₁ is the Q₁ matrix of the vertex v₁, and the secondary error measurement matrix of the vertex v₂ is the Q₂ matrix of the vertex v₂. The new vertex generated after the non-boundary edge l is deleted is p, and the secondary error measurement matrix of p is Qₚ=(Q₁+Q₂).

Coordinates (homogeneous coordinate representation) of the newly generated vertex p are calculated by solving the equation

$$[ \begin{matrix}{q}_{11} & {q}_{12} & {q}_{13} & {q}_{14} \\ {q}_{12} & {q}_{22} & {q}_{23} & {q}_{24} \\ {q}_{13} & {q}_{14} & {q}_{33} & {q}_{34} \\ 0 & 0 & 0 & 1\end{matrix} ] p = [ \begin{matrix}0 \\ 0 \\ 0 \\ 1\end{matrix} ]$$

where qᵢⱼ is a corresponding element in the matrix Qₚ.

When the coefficient matrix in the above equation is invertible, that is, when the matrix Qₚ is an invertible matrix, p is the unique solution of the equation.

When the coefficient matrix in the above equation is not invertible, that is, when the matrix Qₚ is not an invertible matrix, the equation may have infinite number of solutions. In this scenario, it is determined that p=½(v₁+v₂).

Correspondingly, the coordinates of the newly generated vertex p after deleting the non-boundary edge l are determined. Coordinates of newly generated vertices after other non-boundary edges are deleted can be determined accordingly.

The effect of the method for simplifying a three-dimensional mesh model will be illustrated below by using examples.

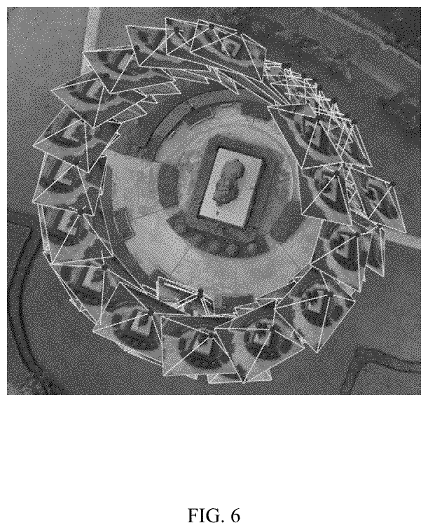

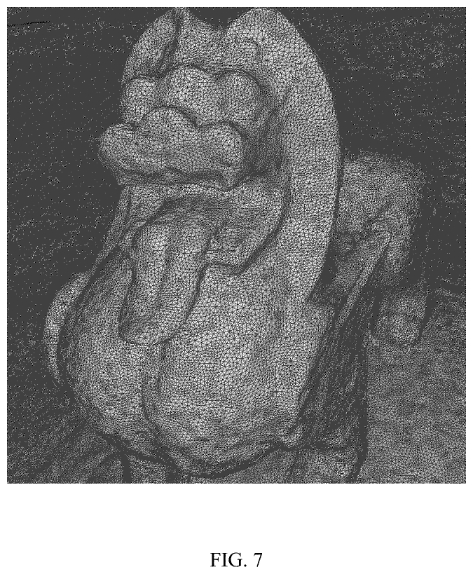

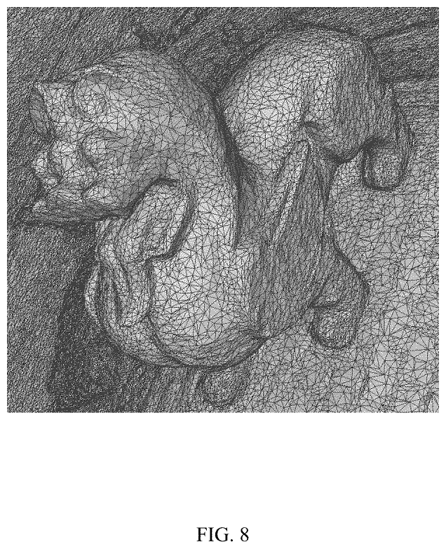

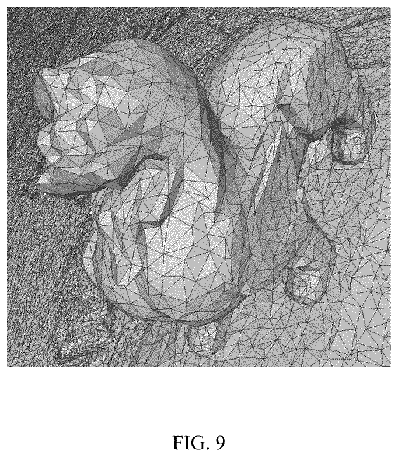

FIG. 6 illustrates a positional relationship between a model object (a stone pixiu) and camera(s). It can be seen that the camera(s) capture photos around the model, that is, the pixiu is close to the camera(s), and the surrounding grass road is far away from the camera(s). FIG. 7 shows the original three-dimensional model before simplification (only a part of it is extracted), and the triangular faces of the model are dense and the details are rich. The simplification result with weight added is shown in FIG. 8, and the simplification result without weight is shown in FIG. 9 (MeshLab decimate result). The number of triangular faces after simplification in FIG. 8 and FIG. 9 are the same.

As shown in FIG. 8, the mesh model obtained by the method provided by the present disclosure has a large number of triangular faces and richer details in the area of interest, while the mesh is sparse in the surrounding areas that are not of interest. The reason is that because of the addition of weights, fewer edges are deleted in the center of the model and more edges are deleted in the periphery of the model.

As shown in FIG. 9, the center and surroundings of the model without weights are deleted according to the same rule, such that there are more edges deleted from the center of the model.

A person of ordinary skill in the art can understand that all or part of the steps in the above method embodiments can be implemented by a program instructing relevant hardware. The program can be stored in a computer-readable storage medium. When the program is executed, the steps of the foregoing method embodiments may be performed. The storage medium may include but not be limited to: a read-only memory (ROM), a random access memory (RAM), a magnetic disk, or an optical disk.

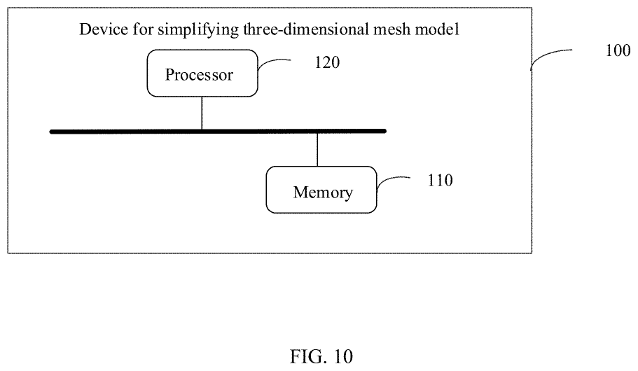

The present disclosure also provides a device for simplifying a three-dimensional mesh model. As shown in FIG. 10, in one embodiment, the device for simplifying a three-dimensional mesh model includes a memory 110 and a processor 120.

The memory 110 is configured to store a computer program.

The processor 120 is configured to execute the computer program. When the computer program is executed, the processor 120 is configured to obtain N non-boundary edges of the three-dimensional mesh model and determine a deletion error of each non-boundary edge of the N non-boundary edges, determine deletion weight of each non-boundary edge of the N non-boundary edges according to feature parameters of two vertices of the non-boundary edge, adjust the deletion error of each non-boundary edge of the N non-boundary edges according to the deletion weight of the non-boundary edge, and simplify the three-dimensional mesh model according to the adjusted deletion error of each non-boundary edge of the N non-boundary edges.

The device for simplifying the three-dimensional mesh model may be configured to execute the method for simplifying the three-dimensional mesh model provided by various embodiments of the present disclosure. The above descriptions can be referred to for the implementation and advantages.

In one embodiment, the processor 120 may be further configured to: for each non-boundary edge of the N non-boundary edges, determine the deletion weight of each vertex of the two vertices of the non-boundary edge according to the feature parameters of the two vertices of the non-boundary edge, and determine the deletion weight of the non-boundary edge according to the deletion weight of each vertex of the two vertices of the non-boundary edge.

In one embodiment, the feature parameters of one vertex may include one or more of the camera distance of the vertex, the curvature at the vertex, and a color value at the vertex.

In one embodiment, the feature parameters of one vertex may include the camera distance of the vertex. Correspondingly, the processor 120 may be further configured to: for each non-boundary edge of the N non-boundary edges, obtain a minimum camera distance among the camera distances of each vertex of the two vertices of the non-boundary edge, and determine the deletion weight of each vertex of the two vertices according to the minimum camera distance corresponding to the vertex. The smaller is the minimum camera distance corresponding to one vertex, the larger the deletion weight of the vertex may be.

In one embodiment, the processor 120 may be configured to use a reciprocal of a square of the minimum camera distance corresponding to one vertex as the deletion weight of the vertex.

In another embodiment, the processor 120 may be configured to: for one vertex, obtain all camera poses associated with the vertex in a coordinate system of the three-dimensional mesh model, determine the camera distances of the vertex cameras according to the camera poses, and use the minimum one among all the camera distances as the minimum camera distance corresponding to the vertex.

In one embodiment, the feature parameters of one vertex may include the curvature at the vertex. Correspondingly, the processor 120 may be further configured to: for each non-boundary edge of the N non-boundary edges, obtain the curvature at each vertex of the two vertices of the non-boundary edge, and determine the deletion weight of each vertex of the two vertices according to the curvature at the vertex. The larger is the curvature at one vertex, the larger the deletion weight of the vertex may be.

In one embodiment, the processor 120 may be configured to use a square of the curvature at one vertex as the deletion weight of the vertex.

In one embodiment, the feature parameters of one vertex may include the color value at the vertex. Correspondingly, the processor 120 may be further configured to: for each non-boundary edge of the N non-boundary edges, obtain the color value at each vertex of the two vertices of the non-boundary edge and the color values at vertices surrounding the two vertices, and determine the deletion weight of each vertex of the two vertices according to the variance between the color value at the vertex and the color values at vertices surrounding the vertex. The smaller is the variance between the color value at the vertex and the color values at vertices surrounding the vertex, the larger the deletion weight of the vertex may be.

In one embodiment, the processor 120 may be further configured to: determine, from the N non-boundary edges, M non-boundary edges each having the corresponding adjusted deletion error smaller than a first preset threshold, where M is a positive integer smaller than or equal to N; and for each non-boundary edge of the M non-boundary edges, delete the two vertices of the non-boundary edge and generate a new vertex, and connect the new vertex to surrounding vertices.

In one embodiment, the processor 120 may be further configured to: sort the N non-boundary edges according to the adjusted deletion errors; delete two vertices of one non-boundary edge of the N non-boundary edges with the smallest deletion error and generate a new vertex; and connect the new vertex to surrounding vertices.

In one embodiment, the processor 120 may be further configured to: determine whether the deletion of the non-boundary edge will cause the triangular face to flip or generate a sharp triangular face; when the deletion of the non-boundary edge will not cause the triangular face to flip or generate a sharp triangular face, delete the non-boundary edge; and generate the new vertex according to the two vertices of the non-boundary edge.

In one embodiment, the processor 120 may be further configured to: for each non-boundary edge of the N non-boundary edges, obtain secondary error measurement matrices of the two vertices of the non-boundary edge; and determine the coordinates of the new vertex according to a sum matrix of the secondary error measurement matrices of the two vertices.

In one embodiment, the processor 120 may be further configured to: when the sum matrix is not an invertible matrix, determine the coordinates of the new vertex according to the coordinates of the two vertices.

In one embodiment, the processor 120 may be further configured to: obtain a number of triangular faces of the three-dimensional mesh model; determine whether the number of the triangular faces of the current three-dimensional mesh model reaches a second preset threshold; when it is determined that the number of the triangular faces reaches the second preset threshold, stop the simplification; and when it is determined that the number of the triangular faces does not reach the second preset threshold, determine the deletion errors of the new non-boundary edges formed by the new vertex and the surrounding vertices, sort the deletion errors of the current non-boundary edges and delete one non-boundary edge of the current non-boundary edges with the smallest deletion error. The above processes are repeated until the number of the triangular faces of the current three-dimensional mesh model reaches the second preset threshold.

In one embodiment, the processor 120 may be further configured to: for each non-boundary edge of the N non-boundary edges, use a product of the deletion weight of the non-boundary edge and the deletion error of the non-boundary edge as the adjusted deletion error of the non-boundary edge.

The device for simplifying the three-dimensional mesh model may be configured to execute the method for simplifying the three-dimensional mesh model provided by various embodiments of the present disclosure. The above descriptions can be referred to for the implementation and advantages.

Part or all of the various embodiments of the present disclosure can be implemented in the form of a software product, and the computer software product may be stored in a storage medium, including several instructions. When the software product is executed, a computer device (which may be a personal computer, a server, or a network device, etc.) or a processor may perform all or some of the processes of the method described in each embodiment of the present disclosure. The aforementioned storage medium may include: a flash disk, a mobile hard disk, a read-only memory (ROM), a random access memory (RAM), a magnetic disk, an optical disk, or another medium that can store program codes.

The various embodiments of the present disclosure may be implemented in whole or in part by software, hardware, firmware, or any combination thereof. When implemented by software, it can be implemented in the form of a computer program product in whole or in part. The computer program product includes one or more computer instructions. When the computer program instructions are loaded and executed on a computer, the processes or functions described in the embodiments of the present disclosure may be generated in whole or in part. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a web site, a computer, a server, or a data center, to another web site, another computer, another server or another data center via wired (such as coaxial cable, optical fiber, digital subscriber line (DSL)) or wireless (such as infrared, wireless, microwave, etc.) connection. The computer-readable storage medium may be any usable medium that can be accessed by a computer or a data storage device such as a server or data center integrated with one or more usable media. The usable medium may be a magnetic medium (for example, a floppy disk, a hard disk, a magnetic tape), an optical medium (for example, a DVD), or a semiconductor medium (for example, a solid state disk (SSD)).

Other embodiments of the disclosure will be apparent to those skilled in the art from consideration of the specification and practice of the embodiments disclosed herein. It is intended that the specification and examples be considered as examples only and not to limit the scope of the disclosure, with a true scope and spirit of the invention being indicated by the following claims.

What is claimed is:

1. A method for simplifying a three-dimensional mesh model comprising:
obtaining N non-boundary edges of the three-dimensional mesh model, N being an integer larger than one;
for each non-boundary edge of the N non-boundary edges:
determining a deletion error of the non-boundary edge;
determining a deletion weight of the non-boundary edge according to a feature parameter of each vertex of two vertices of the non-boundary edge; and
adjusting the deletion error of the non-boundary edge according to the deletion weight of the non-boundary edge to obtain an adjusted deletion error of the non-boundary edge; and
simplifying the three-dimensional mesh model according to the adjusted deletion errors of the N non-boundary edges.

2. The method according to claim 1, wherein determining the deletion weight of the non-boundary edge includes:
for each vertex of the two vertices of the non-boundary edge, determining a deletion weight of the vertex according to the feature parameter of the vertex; and
determining the deletion weight of the non-boundary edge according to the deletion weights of the two vertices of the non-boundary edge.

3. The method according to claim 2, wherein:
the feature parameter of the vertex includes a camera distance of the vertex, a curvature at the vertex, or a color value at the vertex.

4. The method according to claim 3, wherein:
the feature parameter of the vertex includes the camera distance of the vertex; and
determining the deletion weight of the vertex includes:
obtaining a minimum camera distance corresponding to the vertex among all candidate camera distances of the vertex; and
determining the deletion weight of the vertex according to the minimum camera distance of the vertex, the deletion weight of the vertex being negatively correlated to the minimum camera distance corresponding to the vertex.

5. The method according to claim 4, wherein determining the deletion weight of the vertex according to the minimum camera distance corresponding to the vertex includes:
determining a reciprocal of a square of the minimum camera distance corresponding to the vertex as the deletion weight of the vertex.

6. The method according to claim 4, wherein obtaining the minimum camera distance corresponding to the vertex includes:
obtaining camera poses when capturing photos for the three-dimensional mesh model in a coordinate system of the three-dimensional mesh model;
determining the candidate camera distances of the vertex according to the camera poses; and
determining a minimum one among the candidate camera distances as the minimum camera distance corresponding to the vertex.

7. The method according to claim 3, wherein:
the feature parameter of the vertex includes the curvature at the vertex; and
determining the deletion weight of the vertex includes:
obtaining the curvature at the vertex; and
determining the deletion weight of the vertex according to the curvature at the vertex, the deletion weight of the vertex being positively correlated to the curvature at the vertex.

8. The method according to claim 7, wherein determining the deletion weight of the vertex according to the curvature at the vertex includes:
determining a square of the curvature at the vertex as the deletion weight of the vertex.

9. The method according to claim 3, wherein:
the feature parameter of the vertex includes the color value at the vertex; and
determining the deletion weight of the vertex includes:
obtaining the color value at the vertex and color values at surrounding vertices surrounding the vertex; and
determining the deletion weight of the vertex according to a color variance between the color value at the vertex and the color values at the surrounding vertices, the deletion weight of the vertex being negatively correlated to the color variance.

10. The method according to claim 1, wherein simplifying the three-dimensional mesh model according to the adjusted deletion errors of the N non-boundary edges includes:
determining, from the N non-boundary edges, M non-boundary edges each having the corresponding adjusted deletion error smaller than a preset threshold, M being a positive integer smaller than or equal to N; and
for each non-boundary edge of the M non-boundary edges:
deleting the two vertices of the non-boundary edge and generating a new vertex; and
connecting the new vertex to surrounding vertices.

11. The method according to claim 10, wherein deleting the two vertices of the non-boundary edge and generating the new vertex include:
determining whether deletion of the non-boundary edge will cause triangular face flipping or generate a sharp triangular face; and
in response to determining that the deletion of the non-boundary edge will not cause the triangular face flipping or generate the sharp triangular face, deleting the non-boundary edge and generating the new vertex according to the two vertices of the non-boundary edge.

12. The method according to claim 11, wherein generating the new vertex according to the two vertices of the non-boundary edge includes:
obtaining secondary error measurement matrices of the two vertices of the non-boundary edge; and
determining coordinates of the new vertex according to a sum matrix of the secondary error measurement matrices of the two vertices.

13. The method according to claim 12, wherein determining the coordinates of the new vertex according to the sum matrix includes:
in response to the sum matrix being not an invertible matrix, determining the coordinates of the new vertex according to coordinates of the two vertices.

14. The method according to claim 1, wherein simplifying the three-dimensional mesh model according to the adjusted deletion errors of the N non-boundary edges includes:
sorting the N non-boundary edges according to the adjusted deletion errors;
deleting the two vertices of one of the N non-boundary edges with a smallest adjusted deletion error and generating a new vertex; and
connecting the new vertex to surrounding vertices.

15. The method according to claim 14, further comprising, after connecting the new vertex to the surrounding vertices:
obtaining a number of triangular faces of the three-dimensional mesh model;
determining whether the number of the triangular faces of the three-dimensional mesh model reaches a preset threshold;
in response to determining that the number of the triangular faces reaches the preset threshold, stopping simplification; and
in response to determining that the number of the triangular faces has not reached the second preset threshold:
determining the deletion errors of new non-boundary edges formed by the new vertex and the surrounding vertices;
sorting the deletion errors of all current non-boundary edges;
deleting one of the current non-boundary edges with a smallest deletion error; and
repeating until the number of the triangular faces of the three-dimensional mesh model reaches the preset threshold.

16. The method according to claim 1, wherein adjusting the deletion error of the non-boundary edge includes:
obtaining a product of the deletion weight of the non-boundary edge and the deletion error of the non-boundary edge as the adjusted deletion error of the non-boundary edge.

17. A device for simplifying a three-dimensional mesh model comprising:
a memory storing a computer program; and
a processor configured to execute the computer program to:
obtain N non-boundary edges of the three-dimensional mesh model, N being an integer larger than one;
for each non-boundary edge of the N non-boundary edges:
determine a deletion error of the non-boundary edge;
determine a deletion weight of the non-boundary edge according to a feature parameter of each vertex of two vertices of the non-boundary edge; and
adjust the deletion error of the non-boundary edge according to the deletion weight of the non-boundary edge to obtain an adjusted deletion error of the non-boundary edge; and
simplify the three-dimensional mesh model according to the adjusted deletion errors of the N non-boundary edges.

18. The device according to claim 17, wherein:
the processor is further configured to execute the computer program to:
for each vertex of the two vertices of the non-boundary edge, determine a deletion weight of the vertex according to the feature parameter of the vertex; and
determine the deletion weight of the non-boundary edge according to the deletion weights of the two vertices of the non-boundary edge; and
the feature parameter of the vertex includes a camera distance of the vertex, a curvature at the vertex, or a color value at the vertex.

19. The device according to claim 17, wherein:
the processor is further configured to execute the computer program to:
determine, from the N non-boundary edges, M non-boundary edges each having the corresponding adjusted deletion error smaller than a preset threshold, M being a positive integer smaller than or equal to N; and
for each non-boundary edge of the M non-boundary edges:
delete the two vertices of the non-boundary edge and generate a first new vertex; and
connect the first new vertex to vertices surrounding the first new vertex; or
the processor is further configured to execute the computer program to:
sort the N non-boundary edges according to the adjusted deletion errors;
delete the two vertices of one of the N non-boundary edges with a smallest adjusted deletion error and generate a second new vertex; and
connect the second new vertex to vertices surrounding the second new vertex.

20. The device according to claim 17, wherein the processor is further configured to execute the computer program to:
obtain a product of the deletion weight of the non-boundary edge and the deletion error of the non-boundary edge as the adjusted deletion error of the non-boundary edge.
